(19) United States
(12) Patent Application Publication
(10) Pub. No.: US 2020/0020173 A1
(43) Pub. Date: Jan. 16, 2020

(54) METHODS AND SYSTEMS FOR CONSTRUCTING AN ANIMATED 3D FACIAL MODEL FROM A 2D FACIAL IMAGE

(71) Applicant: Zohirul SHARIF, San Jose, CA (US)

(72) Inventor: Zohirul SHARIF, San Jose, CA (US)

(21) Appl. No.: 16/036,909

(22) Filed: Jul. 16, 2018

(51) Int. Cl. G06T 19/20; G06T 17/20; G06T 13/40; G06T 3/60; G06T 15/04; G06T 15/50

(52) U.S. Cl. CPC G06T 19/20; G06T 17/20; G06T 13/40; G06T 7/90; G06T 15/04; G06T 15/50; G06T 2200/24; G06T 3/60

(57) ABSTRACT

Embodiments provide methods and systems for rendering a 3D facial model from a 2D facial image. A method includes receiving, by a processor, a plurality of facial graphics data associated with the 2D facial image of a user, where the plurality of facial graphics data includes a 2D polygonal facial mesh, a facial texture, and a skin tone. The method further includes displaying user interfaces for receiving a user input for modifying facial features in the 2D polygonal facial mesh integrated with facial texture and skin tone. The method further includes morphing the 2D polygonal facial mesh to a generic 3D head model. Further, a facial prop is selected for morphing the prop to adapt to the 3D facial model. Thereafter, the method includes rendering the 3D facial model by exporting a prop occlusion texture associated with the facial prop and applying user inputs for animating the 3D facial model.

### TECHNICAL FIELD

The present disclosure relates to image processing techniques and, more particularly to, methods and systems for constructing a three dimensional (3D) facial model from a two dimensional (2D) facial image.

### BACKGROUND

Social networking has grown to become a ubiquitous and integral part of human life greatly influencing the way people communicate with each other. Electronic devices such as smartphones, tablet computers and the like, include several applications for social networking for exchanging messages or content through various communication means including e-mail, instant messaging, chat rooms, bulletin and discussion boards, gaming applications, and blogs. Moreover, social networking connects people with friends, acquaintances, and enables them to share interests, pictures and videos, and the like. Accordingly, the trend of rendering 3D facial models from 2D facial images has become popular for creating a more interacting environment for the users of social networking or online gaming environment.

The 3D facial model enables the user to animate and render 3D characters such as, animated characters, virtual characters or avatars of the users on social networking websites/applications for communicating and interacting with friends or acquaintances. Moreover, facial props such as hairstyles, fashion accessories or facial expressions can be added to the 3D facial models to provide a realistic representation of the user.

Typically, various techniques exist for rendering an animated 3D facial model of a user. In many example scenarios, special equipments such as cameras equipped with depth sensors may be used to obtain depth information from the facial image of the user. In another illustrative example, multiple facial images may be required to determine the depth information and subsequently generate the 3D facial model. However, the use of multiple facial images for generating the 3D facial model of the user may add an extra layer of difficulty in generating the 3D facial model. Moreover, a facial image of the user looking straight at a camera module may be highly preferred to generate the 3D facial model. For instance, the straight facial image may help in acquiring an accurate facial shape (referred to hereinafter as ‘silhouette’). An accurate silhouette provides a better approximation of the facial shape of the user. However, if the user's face is tilted upwards or downwards then a distorted facial shape may be obtained. Moreover, the distorted facial shape may cause difficulty in determining an approximate jawline for the 3D facial model. For instance, if the face is tilted, the vertical face proportions from nose to mouth and from mouth to chin may be distorted. Consequently, jawline of the 3D facial model may differ from actual jawline of the user.

Furthermore, ambient effects such as lighting and color data play are crucial factors for rendering a realistic 3D facial model. For example, facial props applied on the 3D facial model may look unreal when the ambient effect and color are not matching with the 3D facial model. In an example scenario, shadow casted on lower portion of the 3D facial model such as mouth portion including teeth may change when there is a movement due to smiling or opening of the mouth. In such cases, the lighting on the 3D facial model must adapt to reflect the changes due to the movement.

In many example scenarios, the facial props do not adapt to match the 3D facial model of the user. For example, structure and shape of head varies from one person to another, so when a facial prop is added to the 3D facial model of the user, the facial prop may not fit with the 3D facial model. The facial prop needs to adapt such that it appears proportionate with that of the 3D facial model of the user. Moreover, color data from the 2D facial image may be required to determine the lighting on the 3D facial model when a prop is applied to the 3D facial model. However, acquiring lighting information from the 2D facial image may be difficult when the facial image of the user is turned away to face a specific side or the face of the user is occluded by objects such as hair, glasses or other accessories.

Accordingly, there is a need to create an animated customizable 3D facial model with facial props that appears realistic, while precluding difficulty and complexity of using multiple 2D images.

### SUMMARY

Various embodiments of the present disclosure provide systems, methods, electronic devices and computer program products for facilitating construction of a customizable 3D facial model from a 2D facial image of a user.

In an embodiment, a method is disclosed. The method includes, receiving, by a processor, a plurality of facial graphics data associated with a two dimensional (2D) facial image of a user. The plurality of facial graphics data includes at least a 2D polygonal facial mesh, a facial texture, and a skin tone. The method also includes facilitating display of one or more UIs, by the processor, for receiving a first user input for modifying one or more facial features in the 2D polygonal facial mesh integrated with the facial texture and the skin tone. The method further includes upon modifying the one or more facial features in the 2D polygonal facial mesh, by the processor, morphing the 2D polygonal facial mesh to a generic three dimensional (3D) head model for generating a 3D facial model of the user. The method further includes facilitating, by the processor, selection of at least one facial prop from a plurality of facial props for morphing the at least one facial prop to adapt to the 3D facial model. The method further includes rendering, by the processor, the 3D facial model by performing at least: exporting a prop occlusion texture associated with the at least one facial prop for modulating lighting value on the 3D facial model and applying a second user input comprising at least one facial expression for animating the 3D facial model thereby morphing the at least one facial prop based on the second user input.

In another embodiment, a mobile device for use by a user is disclosed. The mobile device comprises an image capturing module and a processor. The image capturing module is configured to capture a 2D facial image of the user. The processor is in operative communication with the image capturing module. The processor is configured to determine a plurality of facial graphics data from the 2D facial image. The plurality of facial graphics data includes at least a 2D polygonal facial mesh, a facial texture, and a skin tone. The processor is also configured to facilitate display of one or more UIs, by the processor, for receiving a first user input for modifying one or more facial features in the 2D polygonal facial mesh integrated with the facial texture and the skin tone. Upon modifying the one or more facial features in the 2D polygonal facial mesh, morph the 2D polygonal facial mesh to a generic three dimensional (3D) head model for generating a 3D facial model of the user. The processor is further configured to facilitate selection of at least one facial prop from a plurality of facial props for morphing the at least one facial prop to adapt to the 3D facial model. The processor is further configured to render the 3D facial model by performing at least: exporting a prop occlusion texture associated with the at least one facial prop for modulating lighting value on the 3D facial model and applying a second user input comprising at least one facial expression for animating the 3D facial model thereby morphing the at least one facial prop based on the second user input.

In yet another embodiment, a server system is disclosed. The server system comprises a database and a processing module. The database is configured to store executable instructions for an animation application. The processing module is in operative communication with the database. The processing module is configured to provision the animation application to one or more user devices upon request. The processing module is configured to determine a plurality of facial graphics data associated with a 2D facial image of a user. The plurality of facial graphics data comprising at least a 2D polygonal facial mesh, a facial texture, and a skin tone. The processing module is also configured to send the plurality of facial graphics data to a mobile device comprising an instance of the animation application. The mobile device is configured to facilitate display of one or more UIs for receiving a first user input for modifying one or more facial features in the 2D polygonal facial mesh integrated with the facial texture and the skin tone. Upon modifying the one or more facial features in the 2D polygonal facial mesh, morph the 2D polygonal facial mesh to a generic three dimensional (3D) head model for generating a 3D facial model of the user. The mobile device is also configured to facilitate selection of at least one facial prop from a plurality of facial props for morphing the at least one facial prop to adapt to the 3D facial model. The mobile device is further configured to render the 3D facial model by performing at least: exporting a prop occlusion texture associated with the at least one facial prop for modulating lighting value on the 3D facial model and applying a second user input comprising at least one facial expression for animating the 3D facial model thereby morphing the at least one facial prop based on the second user input.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment, in which at least some example embodiments of the present disclosure can be implemented;

FIG. 2 illustrates a block diagram representation of an image processing module of FIG. 1 for extracting a plurality of facial graphics data from a 2D facial image, in accordance with an example embodiment of the present disclosure;

FIG. 3 illustrates a block diagram representation of an animation module for rendering a 3D facial model based on a plurality of facial graphics data associated with the 2D facial image, in accordance with an example embodiment of the present disclosure;

FIG. 4A illustrates a 2D facial image of a user captured using a camera module;

FIG. 4B illustrates a plurality of first facial landmark points determined from the 2D facial image of FIG. 4A, in accordance with an example embodiment of the present disclosure;

FIG. 4C illustrates aligning the 2D facial image and the plurality of first facial landmark points of FIG. 4B on a horizontal line using one or more transforms, in accordance with an example embodiment of the present disclosure;

FIG. 4D illustrates the plurality of first facial landmark points of FIG. 4C aligned on a horizontal line, in accordance with an example embodiment of the present disclosure;

FIG. 4E illustrates a 2D polygonal facial mesh created from the plurality of first facial landmark points of FIG. 4D, in accordance with an example embodiment of the present disclosure;

FIG. 4F illustrates the 2D facial image of FIG. 4C for applying one or more averaging techniques depicting a symmetrical facial structure based on a direction associated with the facial profile, in accordance with an example embodiment of the present disclosure;

FIG. 4G illustrates applying one or more averaging techniques on a 2D facial image depicting at least a symmetrical jawline for the 2D facial image based on direction associated with the facial profile, in accordance with an example embodiment of the present disclosure;

FIG. 4H illustrates a plurality of second facial landmark points obtained by applying one or more averaging techniques on the first facial landmark points of FIG. 4F, in accordance with an example embodiment of the present disclosure;

FIG. 4I illustrates the 2D polygonal mesh of FIG. 4E updated based on the plurality of second facial landmark points of FIG. 4H, in accordance with an example embodiment of the present disclosure;

FIG. 4J illustrates an example representation of extracting a plurality of skin tones from the 2D facial image of FIG. 4C, in accordance with an example embodiment of the present disclosure;

FIG. 4K illustrates an example representation of generating facial texture from the 2D facial image of FIG. 4C, in accordance with an example embodiment of the present disclosure;

FIG. 5A illustrates an example representation of mapping the plurality of facial graphics data extracted by the image processing module of FIG. 2 on a 3D generic head model, in accordance with an example embodiment of the present disclosure;

FIG. 5B illustrates an example representation of projecting the facial texture at a plurality of coordinates on a 3D generic head model via a planar projection, in accordance with an example embodiment of the present disclosure;

FIG. 6A illustrates an example representation of a UI displaying a 3D facial model of a user on an application interface for animating the 3D facial model generated from the 2D facial image of FIG. 4A, in accordance with an example embodiment of the present disclosure;

FIG. 6B illustrates an example representation of a UI displayed to a user on a display screen of a mobile device by the application interface, in accordance with an example embodiment of the present disclosure;

FIG. 6C illustrates an example representation of a UI displayed to the user on the display screen of the mobile device by the application interface depicting a facial prop on the 3D facial model of FIG. 6B, in accordance to an example embodiment of the present disclosure;

FIG. 6D illustrates an example representation of a UI displayed to the user on a display screen of the mobile device of FIG. 10 by the application interface for providing a first user input related to customization of the 3D facial model, in accordance to an example embodiment of the present disclosure;

FIG. 6E illustrates an example embodiment of a UI displayed to the user on a display screen of the mobile device of FIG. 10 by the application interface displaying customization of props added to the 3D facial model, in accordance to an example embodiment of the present disclosure;

FIG. 7A illustrates an example representation of a facial prop, in accordance with an example embodiment of the present disclosure;

FIG. 7B illustrates an example representation of exporting the facial prop of FIG. 7A as a 3D hair prop skeletal mesh for morphing to a user 3D head model, in accordance with an example embodiment of the present disclosure;

FIG. 7C illustrates an example representation of a prop occlusion texture exhibited by the facial prop of FIG. 7A when morphed on the user 3D head model, in accordance with an example embodiment of the present disclosure;

FIG. 8 illustrates a flow diagram depicting a method for rendering a 3D facial model from a 2D facial image, in accordance with an example embodiment of the present disclosure;

FIG. 9 illustrates a block diagram representation of a server capable of implementing at least some embodiments of the present disclosure; and

FIG. 10 illustrates a mobile device capable of implementing various embodiments of the present invention.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

In many example scenarios, a 3D facial model of a user may be generated from multiple 2D facial images of the user increasing complexity of generating the 3D facial model. Moreover, in some other scenarios, depth information of facial features is captured so as to render a realistic 3D facial image from the 2D facial image. However, determining depth information may require additional hardware such as, camera modules equipped with depth sensors for determining the depth information. In addition, accurate information of color data and lighting value may be required for rendering an accurate and a realistic 3D facial model. In some other scenarios, facial props added to animate the 3D facial model may not morph automatically to match the 3D facial model thereby providing an unrealistic appearance or mismatch of props on the 3D facial model. Furthermore, facial features such as eyes, mouth, lips or teeth may be required to move cohesively when facial expressions of the 3D facial model is animated to depict facial expressions. As the 3D facial model depicts the user, the user may intend to modify facial features so as to animate the 3D facial model and enhance the appearance. Accordingly to address these, various example embodiments of the present disclosure provide methods, systems, mobile devices and computer program products for rendering a 3D facial image from a 2D facial image that overcome above-mentioned obstacles and provide additional advantages. More specifically, techniques disclosed herein enable customization of the 3D facial model by the user.

In an embodiment, the user may provide a 2D facial image of the user via an application interface of a mobile device for generating a 3D facial model corresponding to the 2D facial image. The 2D facial image may be captured using a camera module of the mobile device. Alternatively, the user may provide the 2D facial image stored in a memory of the mobile device. Moreover, the 2D facial image may be provided from other sources, such as a social media account or an online gaming profile of the user. It may be noted here that the 2D facial image may include a face of the user or a face of any other person that the user intends to animate and generate as the 3D facial model. The 2D facial image of the user is sent from the mobile device to a server system via the application interface. In one embodiment, the user may access the application interface to send a request to the server system. The request includes the 2D facial image provided by the user and a request for processing the 2D facial image.

In at least one example embodiment, the server system is configured to determine a plurality of facial graphics data from the 2D facial image. The plurality of facial graphics data includes at least a 2D polygonal facial mesh, a facial texture, and a skin tone. The server system is configured to determine a plurality of first facial landmark points from the 2D facial image. The 2D facial image along with the plurality of first facial landmark points are rotated so as to align the 2D facial image on a straight horizontal line using one or more transform techniques. In at least one example embodiment, the server system employs one or more averaging techniques on the plurality of first facial landmark points based on a golden ratio for generating a plurality of second facial landmark points. The plurality of second facial landmark points depicts a symmetrical facial structure corresponding to the 2D facial image. For example, a direction associated with a facial profile of the 2D facial image from the plurality of first facial landmark points is determined. The facial profile of the 2D facial image may include at least one of a left side profile and a right side profile. Based on the direction, a set of facial landmark points being at least one of a left side facial landmark points associated with the left side profile or a right side facial landmark points associated with the right side profile is selected. Using the set of facial landmark points, a symmetrical facial structure corresponding to the 2D facial image is generated. The method of generating the symmetrical facial structure of the 2D facial image further includes defining at least a jawline for the 2D facial image based on direction associated with facial profile. A rate of change in the set of facial landmark points is determined based on the selection of the set of facial landmark points being at least one of a left side facial landmark points associated with the left side profile or a right side facial landmark points associated with the right side profile. The rate of change associated with the set of facial landmark points to the jawline is then applied and a symmetric jawline on the symmetrical facial structure is displayed.

In an example embodiment, the server system generates the 2D polygonal facial mesh from the plurality of second facial landmark points. Further, the server system is configured to extract the facial texture and the skin tone of the user from the 2D facial image. The facial texture is extracted from the 2D facial image in such a way that lighting effect of the 2D facial image is preserved. In an example, generating the facial texture includes removing a plurality of pixels from the 2D facial image and replacing the plurality of pixels for preserving the lighting effects of the 2D facial image by performing a sampling of the skin tone. The skin tone is sampled from one or more pixels extracted from left side, frontal side and right side. From the 2D facial image, a plurality of pixels are removed and replaced by pixels that are based on a sampling of skin tone extracted from left side, frontal side and right side of the face. Furthermore, skin tone from the 2D facial image is extracted from a left side, a frontal side of a nose lobe and a right side of the face in the 2D facial image. The server system sends the facial graphics data to the mobile device via the application interface.

The plurality of facial graphics data is parsed by the mobile device to determine the 2D polygonal facial mesh, the facial texture and the skin tone. The 2D polygonal facial mesh is integrated with the facial texture and skin tone using a real-time application program interface (API). The 2D polygonal facial mesh with the facial texture and the skin tone is presented to user on the application interface. In at least one example embodiment, the server system may cause display of one or more UIs for the user to provide a first user input on the application interface for modifying facial features such as, face width, a face straightening, eye scaling and a jawline of the 2D polygonal facial mesh.

Moreover, the application interface is configured to load a 3D generic head model upon receipt of the plurality of facial graphics data. The 2D polygonal facial mesh along with the facial texture and the skin tone are morphed to the 3D head model.

In at least one example embodiment, the application interface is caused to display a plurality of facial props such as hair masks, eye masks, fashion accessories and the like. The user can select one or more facial props from the plurality of facial props on the application interface. Optionally, the user can chose to modify facial expressions of the 3D head model to render an animated facial expression on the 3D facial model by providing a second user input. The second user input modifies the plurality of facial graphics data to depict the animated facial expression provided by the second user input. In order to render the realistic 3D facial model, lighting effect on the 3D facial model is rendered based on the facial texture and skin tones from the facial graphics data. Moreover, facial features such as eyes and teeth may be rendered separately so as to acquire a dynamic 3D facial model when the facial expressions are animated to the 3D facial model. When the facial props are morphed to the 3D head model, shadows are casted using occlusion texture. The 3D facial model may then be exported or shared to other applications for rendering a 3D model such as an avatar.

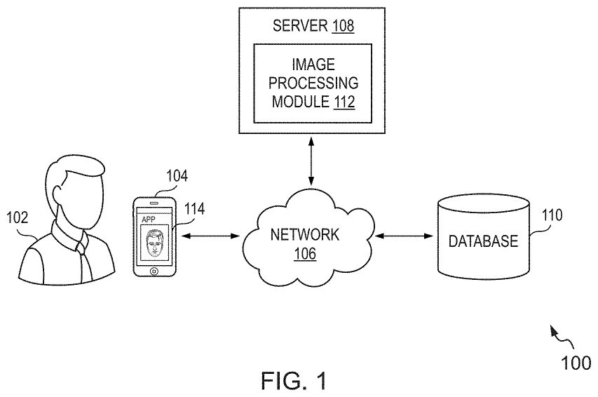

The 3D facial model rendered from a single 2D facial image using facial graphics data is further explained in detail with reference to FIGS. 1 to 10.

FIG. 1 illustrates an example representation of an environment 100, in which at least some example embodiments of the present disclosure can be implemented. The environment 100 is depicted to include a user 102 associated with a mobile device 104. The mobile device 104 may be a mobile device capable of connecting to a communication network, such as a network 106. Some examples of the mobile device 104 may include laptops, smartphones, desktops, tablets, wearable devices, workstation terminals, and the like. The network 106 may include wired networks, wireless networks and combinations thereof. Some non-limiting examples of the wired networks may include Ethernet, local area networks (LANs), fiber-optic networks, and the like. Some non-limiting examples of the wireless networks may include cellular networks like GSM/3G/4G/5G/LTE/CDMA networks, wireless LANs, Bluetooth, Wi-Fi or Zigbee networks, and the like. An example of the combination of wired and wireless networks may include the Internet.

The environment 100 is further depicted to include a server 108 and a database 110. The database 110 may be configured to store previously generated one or more 3D facial models of the user 102 and instructions for generating and rendering the 3D facial model of the user 102. In some embodiments, the database 110 may store 3D models generated by an image processing module 112. In at least one example embodiment, the image processing module 112 may be embodied in the server 108. In an example embodiment, the mobile device 104 may be equipped with an instance of an application 114 installed therein. The application 114 and its components may rest in the server 108 and the mobile device 104. The mobile device 104 can communicate with the server 108 through the application 114 via the network 106.

The application 114 is a set of computer executable codes configured to send a request to the server 108 and receive facial graphics data from the server 108. The request includes a 2D facial image of the user 102 and a request for processing the 2D facial image. Once the server 108 receives the request, the 2D facial image is processed by the image processing module 112 for extracting the facial graphics data. The set of computer executable codes may be stored in a non-transitory computer-readable medium of the mobile device 104. The application 114 may be a mobile application or a web application. It must be noted that the term ‘application 114’ is interchangeably referred to as an ‘application interface 114’ throughout the disclosure. The user 102 may request the server 108 to provision access to the application over the network 106. Alternatively, in some embodiments, the application 114 may be factory installed within the mobile device 104 associated with the user 102. In some embodiments, the server 108 may provision 3D model rendering application services as a web service accessible through a website. In such a scenario, the user 102 may access the website over the network 106 using web browser applications installed in their mobile device 104 and thereafter render 3D models.

Furthermore, the mobile device 104 may include an image capturing module associated with one or more cameras to capture the 2D facial image of the user 102. It may be noted here that the camera may include a guidance overlay on preview of a camera feed that helps in capturing the 2D facial image of the user 102 that is aligned with the guidance overlay. The 2D facial image may then be processed for extracting facial graphics data and use the facial graphics data for rendering a 3D model of the user 102. In an alternative embodiment, the user 102 may provide the 2D facial image that is stored in a storage unit of the mobile device 104. In yet another embodiment, the 2D facial image may be obtained from other sources such as a social media account of the user 102 or from the database 110. In some other embodiment, the server 108 may receive an initiation from the user 102 via the application interface 114. The initiation may include a request associated with a 2D facial image from the user 102.

In some scenarios, the 2D facial image may be tilted downwards or upwards. At such scenarios, facial proportions of the 2D facial image may be distorted for rendering the 3D facial model. In one example embodiment, the facial proportions of the 2D facial image may be approximated by applying golden ratio of a human face. In another example embodiment, the user 102 may customize the 2D facial image and adjust the facial proportions. For example, the user 102 may dial in golden ratio to straighten a tilted face in the 2D facial image. The facial graphics data may then be morphed to a 3D generic head model. In some embodiments, the 3D facial model may be used in other software programs and computing systems that contain or display 3D graphics such as, online games, virtual reality environments, online chat environments, online shopping platforms or e-commerce environments. In some other embodiments, the 3D facial model may be used for constructing a 3D model of the user 102 that are applicable in personalization of products, services, gaming, graphical content, identification, augmented reality, facial make up, etc. The 3D model of the user 102 may include an animated character, a virtual character, an avatar, etc. For example, the 3D model of the user 102 may be used for trying out online products, different styles and make up looks. Moreover, different customization to the 3D model may be applied based on preferences of the user 102.

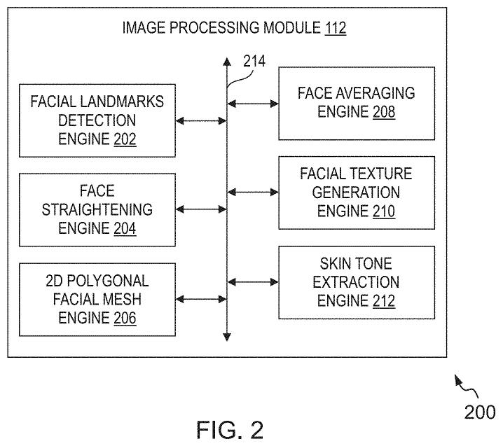

The image processing module 112 is configured to extract the 2D facial graphics data from the 2D facial image provided by the user 102, which is explained further with reference to FIG. 2.

FIG. 2 illustrates a block diagram representation 200 of the image processing module 112 as described in FIG. 1 for extracting facial graphics data from a 2D facial image, in accordance with an example embodiment of the present disclosure. It may be noted that the image processing module 112 may be embodied in a server such as the server 108 as described with reference to FIG. 1. Moreover, the image processing module 112 may be a stand-alone module that can extract the facial graphics data from the 2D facial image. The image processing module 112 includes various engines for extracting the facial graphics data from the 2D facial image. An image processing module 200 includes a facial landmarks detection engine 202, a face straightening engine 204, a 2D polygonal facial mesh engine 206, a face averaging engine 208, a facial texture generation engine 210 and a skin tone extraction engine 212. The components described herein may be implemented by combination of hardware and software.

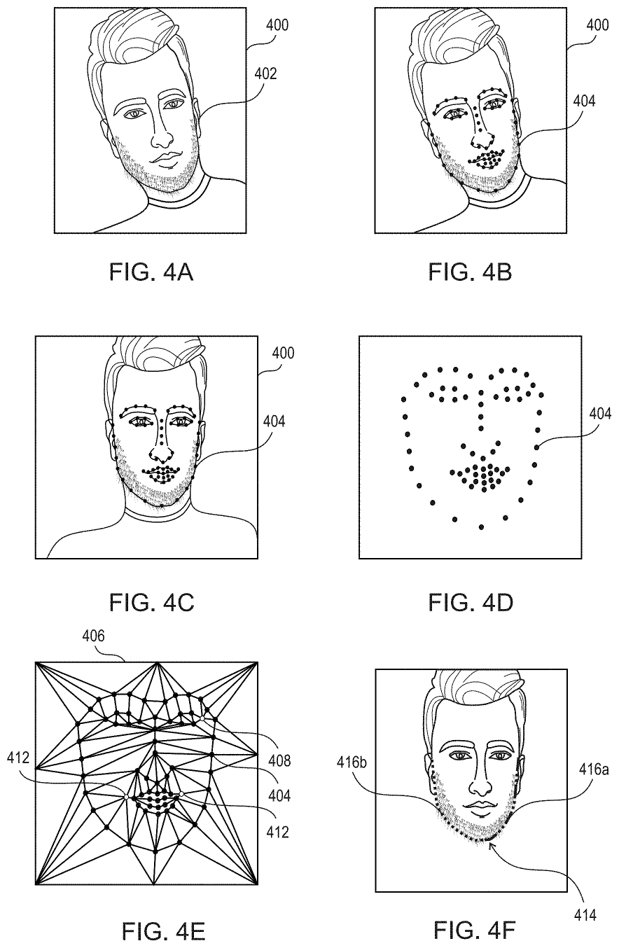

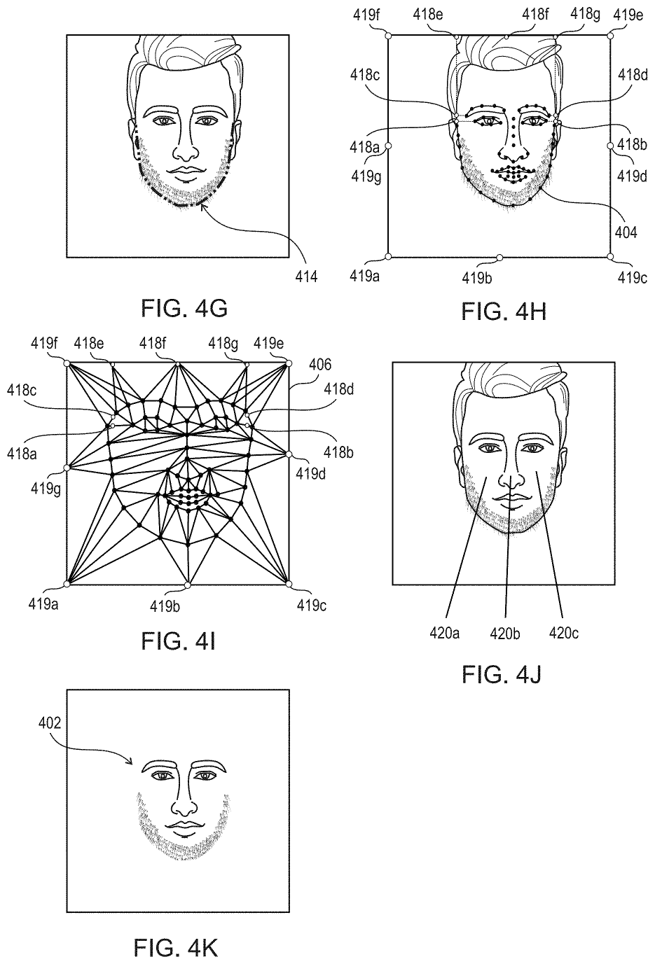

The facial landmarks detection engine 202 detects and extracts facial landmark points of a face in the 2D facial image. The term ‘facial landmark points’ is interchangeably referred to as ‘facial landmarks’ throughout the disclosure. The facial landmarks include points for significant facial features such as eyes, eyebrows, nose lobe, lips and jawline. An example of detecting the facial landmarks is shown and explained with reference to FIG. 4B. In one example embodiment, the facial landmarks detection engine 202 may include one or more library files that help in extracting the facial landmarks from the 2D facial image. For example, the facial landmarks detection engine 202 may detect 68 facial landmark points using the one or more library files. In an example, the 68 facial landmark points include 6 points for each eye, 5 points for each eyebrow, 9 points for nose, 17 points for jawline and 20 points for the lips. In some scenarios, it may happen that the face in the 2D facial image may not be aligned straight such that distorted facial landmarks may be generated. Such 2D facial image can be aligned by the face straightening engine 204.

The face straightening engine 204 is configured to receive the 2D facial image along with the plurality of first facial landmark points from the facial landmarks detection engine 202. Further, the face straightening engine 204 is configured to perform one or more transforms such as rotation and translation to the 2D facial image for aligning the 2D facial image and the plurality of first facial landmark points in a straight horizontal line. After straightening the 2D facial image, a flat triangulated polygonal geometry referred to herein as “2D polygonal facial mesh” is generated by the 2D polygonal facial mesh engine 206.

The 2D polygonal facial mesh engine 206 considers each facial landmark point as a vertex to generate the 2D polygonal facial mesh. The 2D facial image may be transformed by moving position of vertices in the 2D polygonal facial mesh. The transformation by moving the position of vertices enables modifying one or more facial features of the 2D facial image. For example, shape of an eye in the 2D facial image may be modified by moving position of a vertex at an edge of the eyes. If the vertex is moved outwards, the shape of the eye is stretched depicting the eye to appear narrow. Moreover, the eye can be widened by moving the vertex inwards. The 2D polygonal facial mesh is then averaged that is performed in the face averaging engine 208.

The face averaging engine 208 may provide one or more averaging techniques for facilitating a symmetrical structure corresponding to the 2D facial image. The face averaging engine 208 performs averaging on a plurality of first facial landmark points based on a golden ration for generating a plurality of second facial landmark points that depicts the symmetrical facial structure corresponding to the 2D facial image. In one embodiment, the plurality of second facial landmark points includes a set of landmark points that are detected on the symmetrical facial structure corresponding to the 2D facial image. In one example, the set of landmarks points may include 7 facial landmark points added on a face in the 2D facial image and 7 additional landmark points added on edge of the 2D facial image (shown in FIG. 4H). After generating the plurality of second facial landmark points, the 2D polygonal facial mesh generated by the 2D polygonal facial mesh engine 206 is updated, which is shown in FIG. 4I. The one or more averaging techniques may further include determining a direction associated with a facial profile of the 2D facial image from the plurality of first facial landmark points. The direction of the facial profile may include at least one of a left side profile and a right side profile. Based on the direction associated with the facial profile, at least one set of facial landmark points from the left side profile or the right side profile is selected. For example, if the direction is the left side profile, then set of facial landmark points associated with the left side profile is selected for generating the symmetrical facial structure. The symmetrical structure is generated by mirroring the set of facial landmark points based on the selection of facial profile. Moreover, facilitating the symmetric facial structure further includes defining at least a jawline for the 2D facial image based on the direction associated with the facial profile. The mirroring determines a rate of change in the set of facial landmark points based on the selection and applies the rate of change associated with the set of facial landmark points to the jawline. A symmetric jawline is then displayed on the symmetric facial structure, which is shown in FIGS. 4F and 4G.

After averaging the face, a facial texture is generated from the 2D facial image by the facial texture generation engine 210. The facial texture generation engine 210 generates the facial texture by removing a plurality of pixels from the 2D facial image. The plurality of pixels removed are replaced for preserving lighting effects of the 2D facial image by performing a sampling of the skin tone from one or more pixels extracted from a left side, a frontal side and a right side of the 2D facial image. For instance, dark side of the face is filled with darker pixels and brighter side of the face is filled with brighter pixels based on the one or more pixels extracted from the left side, the frontal side and the right side of the 2D facial image.

The facial texture generated by the facial texture generation engine 210 is provided to the skin tone extraction engine 212. The skin tone extraction engine 212 extracts a plurality of skin tones from the 2D facial image. The plurality of skin tones are extracted from at least a left side of the left side profile, a frontal side including nose lobe and a right side of the right side profile. The plurality of skin tones are then used later for estimating lighting effect to be rendered on a 3D facial model.

Various engines of the image processing module 200, such as the facial landmarks detection engine 202, the face straightening engine 204, the 2D polygonal facial mesh engine 206, the face averaging engine 208, the facial texture generation engine 210 and the skin tone extraction engine 212 may be configured to communicate with each other via or through a centralized circuit system 214. The centralized circuit system 214 may be various devices configured to, among other things, provide or enable communication between the engines (202-212) of the image processing module 112. In certain embodiments, the centralized circuit system 214 may be a central printed circuit board (PCB) such as a motherboard, a main board, a system board, or a logic board. The centralized circuit system 214 may also, or alternatively, include other printed circuit assemblies (PCAs) or communication channel media. In some embodiments, the centralized circuit system 214 may include appropriate storage interfaces to facilitate communication among the engines (202-212). Some examples of the storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the image processing module 112 with access to the data stored in a memory (not shown in FIG. 2).

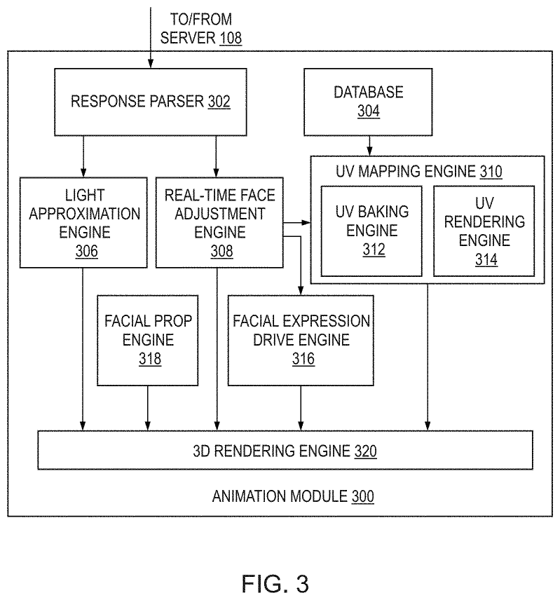

The facial graphics data extracted from the 2D facial image are then used for rendering a 3D facial model of the user 102. The 3D facial model is then used for constructing an avatar of the user 102 by an animation module, which is explained with reference to FIG. 3.

FIG. 3 illustrates a block diagram representation 300 of an animation module 300 for rendering a 3D facial model based on a plurality of facial graphics data associated with a 2D facial image, in accordance with an example embodiment of the present disclosure. The animation module 300 may be embodied in a mobile device, such as the mobile device 104 described in FIG. 1. Alternatively, the animation module 300 may be a stand-alone component capable of rendering a 3D model of the user 102. In one example embodiment, the animation module 300 receives the plurality of facial graphics data from a server such as the server 108 described with reference to FIG. 1. In another example embodiment, the animation module 300 may receive the plurality of facial graphics data from the image processing module 200 (as shown in FIG. 2) embodied in the server 108.

In an embodiment, the animation module 300 includes a response parser 302, a database 304, a light approximation engine 306, a real-time face adjustment engine 308, a UV mapping engine 310, a facial expression drive engine 316, a facial prop engine 318, and a 3D rendering engine 320 for generating the 3D facial model. The animation module 300 further includes the database 304 that stores a generic 3D head model. It shall be noted that although the animation module 300 is depicted to include engines 306, 308, 310, 316, 318 and 320, the animation module 300 may include fewer or more engines than those depicted in FIG. 3.

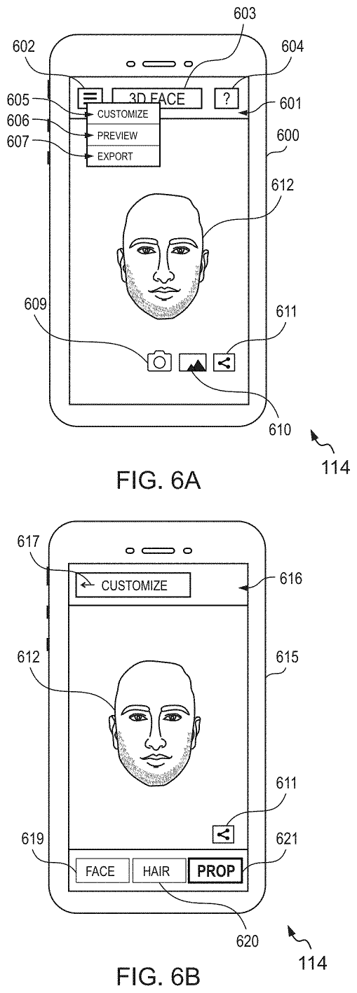

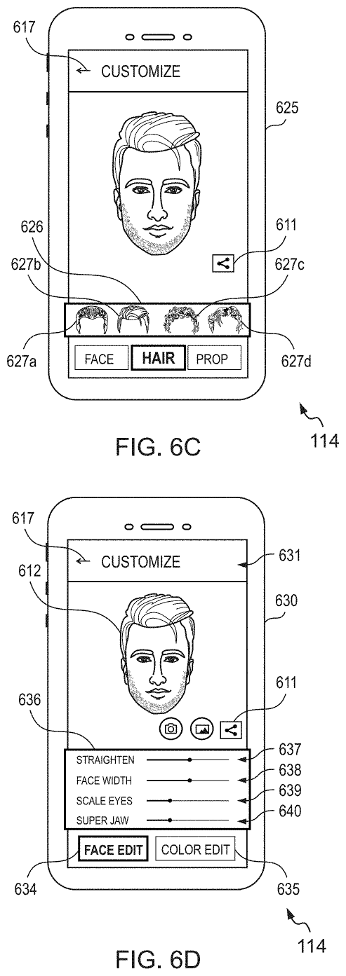

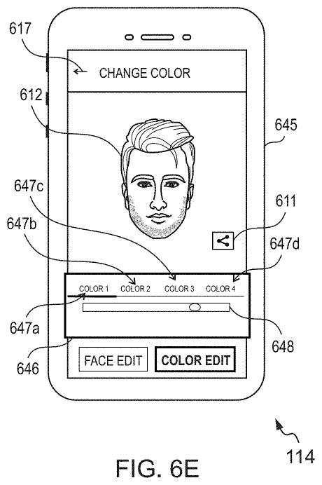

The animation module 300 is configured to receive the plurality of facial graphics data associated with a 2D facial image (see, FIG. 4A). In an embodiment, the response parser 302 is configured to parse the plurality of facial graphics data so as to determine a 2D polygonal facial mesh, a facial texture and a skin tone corresponding to the 2D facial image of the user. The real-time face adjustment engine 308 receives the 2D polygonal facial mesh along with the facial texture and the skin tone from the response parser 302. The real-time face adjustment engine 308 is configured to integrate the 2D polygonal facial mesh with the facial texture and the skin tone for generating the 3D facial model. In an example, the 2D polygonal facial mesh may be integrated with the facial texture and the skin tone using a real-time graphics API. Upon integrating the 2D polygonal facial mesh with the facial texture and the skin tone, the animation module 300 may prompt an application interface such as, the application interface 114 to display one or more UIs for receiving a first user input from a user (e.g., the user 102) associated with the application interface 114. The first user input is received for modifying one or more facial features in the 2D polygonal facial mesh corresponding to the 3D facial model. For example, face width, face alignment, eye scale and jawline can be modified based on the first user input. In an example, face width may be increased or decreased based on the first user input. It shall be noted that when the face width is modified based on the first user input, other facial features remain unaffected. For example, when the face width is increased position of eyes and nose remains unchanged. In a similar manner, shape of eyes may be modified into a bigger or a smaller size based on the first user input. Upon modifying the one or more features in the 3D facial model, the plurality of facial graphics data (2D polygonal facial mesh, the plurality of first facial landmark points, the facial texture and the skin tone) are updated to reflect the changes in the one or more features. An example of modifying one or more facial features of the 3D facial model is shown and explained with reference to FIG. 6D.

Optionally, the real-time face adjustment engine 308 may initially provide changes to the one or more facial features. The user may later provide the first user input for modifying the one or more facial features via an interface such as the application interface 114. In some example scenarios, when the face is straightened certain facial features may be distorted. For instance, ratio of distance between nose and mouth to distance between mouth and chin may be inaccurate, and it may make the 3D facial model appear distorted. In such scenarios, the real-time face adjustment engine 308 may apply a pre-defined golden ratio to correct distance between facial features, such as, distance between the nose and the mouth for generating a more appropriate facial structure.

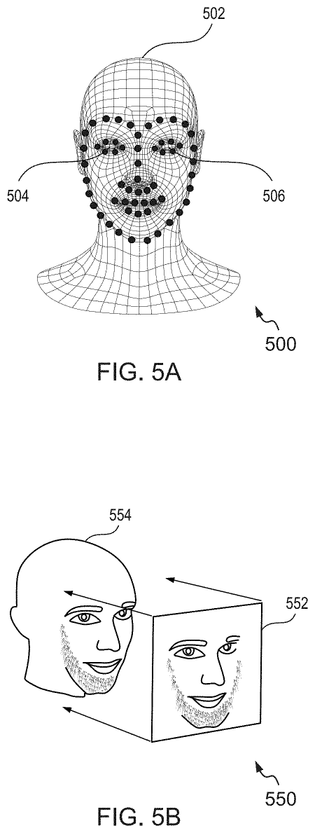

The animation module 300 is configured to load a generic 3D head model from the database 304 for morphing the 2D polygonal facial mesh to the generic 3D head model. The generic 3D head model is exported as a skinned mesh with a plurality of bones. Each bone is associated with a bone weight. In one example embodiment, the generic 3D head model may be exported as the skinned mesh using a 3D authoring tool, for example, Autodesk® 3D Studio Max®, Autodesk Maya® or Blender™. In an example, the plurality of bones may be represented by 64 individual bones that provide a skeleton figure of the generic 3D head model. Each individual bone of the generic 3D head model includes vertices that are attached to one another. Each individual bone is associated with a bone weight that enables vertices in the skinned mesh of the generic 3D head model to move in a realistic manner. The skinned mesh of the generic 3D head model includes a surface referred to herein as skin. The skin is then clad on top of the skeleton figure of the head to generate the generic 3D head model as shown in FIG. 5A.

The plurality of bones is mapped with a plurality of second facial landmark points for adapting each of the bone weight in the skinned mesh. In one example scenario, out of the 64 individual bones, 62 individual bones may be mapped with 62 facial landmark points of a plurality of first facial landmark points. The 62 facial landmark points mapped to the 62 individual bones may include facial landmark points mapped with one bone for scalp and one bone for neck of the generic 3D head model. After loading the generic 3D head model, facial texture is applied by the UV mapping engine 310.

The UV mapping engine 310 includes a UV baking engine 312 and a UV rendering engine 314. The UV mapping engine 310 receives the plurality of facial graphics data from the real-time face adjustment engine 308. From the plurality of facial graphics data facial texture is obtained and projected on the generic 3D head model. The facial texture is projected on the generic 3D head model by the UV baking engine 312 to generate a user 3D head model. The facial texture is projected and baked to the generic 3D head model using a planar projection (shown in FIG. 5B). The planar projection is associated with projection coordinates referred to hereinafter as UV coordinates that are baked to the generic 3D head model. The generic 3D head model includes vertices that are used for baking with the UV coordinates. The UV coordinates are generated by the UV rendering engine 314. The UV coordinates are baked into the vertices of the generic 3D head model. Once the UV coordinates are baked, the facial texture morphs with the vertices of the generic 3D head model generating the user 3D head model. Moreover, baking the UV coordinates into the vertices of the generic 3D head model enables animating expressions on the user 3D head model. The user 3D head model is provided to the 3D rendering engine 320 to generate the 3D facial model.

For each vertex in the generic 3D head model, there exists a UV coordinate in the planar projection. For example, if the generic 3D head model includes 25000 vertices, the planar projection has 25000 UV coordinates corresponding to the 25000 vertices. Accordingly, accurate mapping of the UV coordinates to the vertices in the generic 3D head model may be performed when the vertices of the generic 3D head model are moved based on movement of the bones. The vertices are moved based on movement of the bones through a skinning process. The skinning process enables in updating position of the vertices based on movement of the bones on the generic 3D head model. Moreover, whenever first user input for modifying one or more facial features is applied to the 3D facial model, positions of the bones are updated that causes the vertices to move accordingly. The UV coordinates of each vertex are saved into texture as pixel color data. It must be understood here that each vertex generates a single pixel color data. Each pixel color data is then decoded into XY coordinates and baked into UV coordinates by the UV baking engine 312.

The facial expression drive engine 316 is configured to drive facial expressions by moving one or more bones of the user 3D head model. It shall be noted that a bone movement may vary from person to person when animating a facial expression on the user 3D head model. In one example embodiment, the facial expressions may be stored as bone weights such that application of bone weights on the generic 3D head model can drive expressions on the 3D facial model. In at least one example embodiment, instead of storing actual position of the bones, ratio of change from an original position of bones in the 3D facial model may be stored.

The light approximation engine 306 receives the plurality of skin tones from the response parser 302. The light approximation engine 306 determines an approximated average skin color based on the plurality of skin tones. After determining the approximated average skin color, the light approximation engine 306 renders lighting values for the 3D facial model based on the approximated average skin color. The light approximation engine 306 receives a plurality of skin tones from the response parser 302 and determines an approximated average skin color based on the plurality of skin tones. Using the approximated average skin color, the lighting values for the 3D facial model are rendered. In one example embodiment, the lighting values include four light color values such as ambient light color, left light color, right light color and front light color. The left light color, the right light color and the front light color are obtained by extracting one or more pixels from left side profile, right side profile and frontal side of the nose respectively.

The light approximation engine 306 determines a minimum value color from at least one of the left color, the right color and the front light color. The minimum value color is assigned as the ambient light color. The ambient light color is subtracted from the left light color, the right light color and the front light color. Upon subtracting, the ambient light color, the left light color, the right light color and the front light color are divided by the approximated average skin color for obtaining the lighting values. These lighting values are passed into the 3D rendering engine 320 to render the 3D facial model associated with props and facial expressions.

The 3D rendering engine 320 receives and uses the lighting values from the light approximation engine 306, the 2D polygonal facial mesh integrated with the facial texture and the skin tone from the real-time face adjustment engine 308, the user 3D head model from the UV mapping engine 310, the facial expressions from the facial expression drive engine 316 and the facial prop from the facial prop engine 318, for generating the 3D facial model. The 3D rendering engine 320 generates the 3D facial model by rendering the user 3D representation of head along with facial features such as eyes, teeth, facial props, and facial expressions. In one example embodiment, the 3D rendering engine 320 obtains bone positions from the facial expressions. It may be noted the bone positions are based on the plurality of second facial landmark points that are obtained after applying one or more averaging techniques on the plurality of first facial landmark points. The bone positions are used for rendering skeletal mesh using a skinning process such as the skinning process described in the UV mapping engine 310. The bone positions are used for determining positions of facial features such as eyes and teeth. The 3D rendering engine 320 determines positions of the eyes by averaging bone positions of the eyes. The eyes are placed accordingly on the user 3D head model based on the positions determined by the 3D rendering engine 320. In a similar manner, bone positions of upper teeth is averaged and placed according to bottom nose position on the user 3D head model.

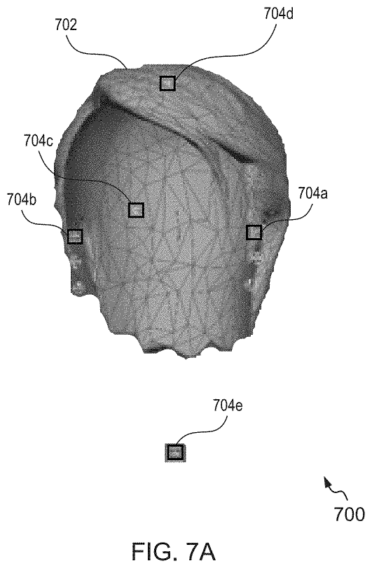

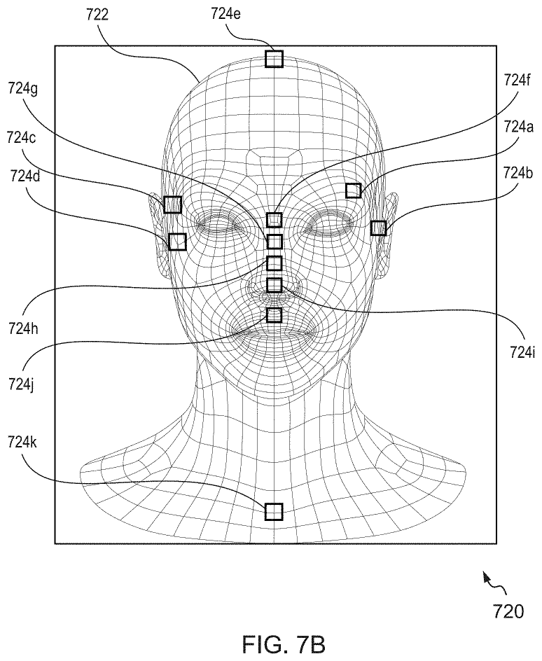

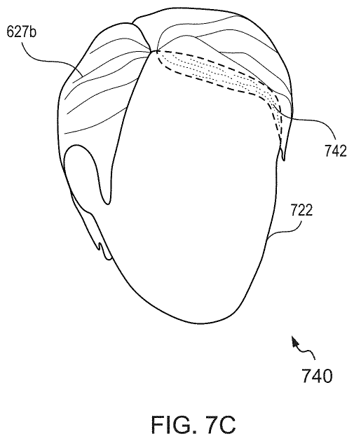

The facial prop engine 318 is configured to morph a facial prop selected by the user on the 3D facial model. In an embodiment, the facial prop engine 318 includes a plurality of facial props that may be displayed on a UI of a device (e.g., the mobile device 104) by an application interface, such as, the application interface 114 for facilitating selection of the facial prop. In an embodiment, the facial prop engine 318 is configured to generate a prop occlusion texture corresponding to the facial prop selected by the user. It must be understood here that the plurality of facial props may include any elements or accessories that are placed on the 3D head model such as hairstyles, glasses, facial hair, makeup, clothing, body parts, etc. An example of generating the prop occlusion texture corresponding to the facial prop is shown and explained with reference to FIGS. 7A to 7C.

In one example embodiment, the plurality of facial props may be authored using the same authoring tools that are used to author the generic 3D head model. The plurality of facial props may be authored using a subset of bones from the generic 3D head model, which is shown in FIGS. 7A and 7B. The plurality of facial props is then exported as texture referred to herein as prop occlusion texture. As shown in FIG. 7C, the prop occlusion texture modulates the facial texture to cast shadows which is projected on the user 3D head model. It shall be noted that whenever a new facial prop is added to the 3D facial model, a prop occlusion texture corresponding to the new facial prop is generated and morphed to fit the 3D facial model. Such an approach helps in creating an illusion that the facial prop is affecting the lighting effect on the 3D facial model and thereby providing a realistic appearance to the 3D facial model.

The extraction of a plurality of facial graphics data for generating a 3D facial model corresponding to a 2D facial image provided by the user is explained with reference to FIGS. 4A to 4K.

FIG. 4A illustrates a 2D facial image 400 of a user (e.g., the user 102 described in FIG. 1) captured using a camera module, in accordance with an example embodiment.

As shown in FIG. 4A, the 2D facial image 400 depicts a face 402 of the user (e.g., the user 102) captured using a camera module of a mobile device such as, the mobile device 104 (shown in FIG. 1). It may be noted here that the 2D facial image 400 may depict the face 402 of the user or any other person of which the user 102 intends to generate a 3D facial model. The camera module may be implemented as a camera application on the mobile device 104. The camera application may include a guidance overlay on a display screen of the mobile device 104 that helps the user 102 to look straight at image capturing component of the camera module when the 2D facial image 400 is being captured. From the face 402, a plurality of facial features can be obtained by identifying facial points unique to the face 402 referred to hereinafter as facial landmark points, which is described with reference to FIG. 4B.

FIG. 4B illustrates a plurality of first facial landmark points 404 determined from the 2D facial image 400 of FIG. 4A, in accordance with an example embodiment. The plurality of first facial landmark points 404 is determined from the 2D facial image 400 by the facial landmarks detection engine 202 as described with reference to FIG. 2. In at least one example embodiment, the facial landmark detection engine 202 may use deep learning techniques that help in extracting the plurality of first facial landmark points of the face 402 from the 2D facial image 400. In an example, the facial landmark detection engine 202 extracts 68 facial landmark points from the 2D facial image 400. The 68 facial landmark points include 12 landmark points representing eyes (6 points for each eye), 10 landmark points representing eyebrows (5 points for each eyebrow), 17 landmark points representing an entire jawline, 9 landmark points representing nose and 20 landmark points representing lips of the face 402. The 68 facial landmark points are referred to herein as the plurality of first facial landmark points 404.

FIGS. 4C and 4D illustrate aligning the 2D facial image 400 and the plurality of first facial landmark points 404 of FIG. 4B on a horizontal line using one or more transforms, in accordance with an example embodiment of the present disclosure. Once the plurality of first facial landmark points 404 are determined, one or more transforms for rotating the 2D facial image 400 and the plurality of first facial landmark points 404 is performed, which are shown in FIGS. 4C and 4D. The 2D facial image 400 and the plurality of first facial landmark points 404 are straightened using the face straightening engine 204 as described in FIG. 2. One or more transforms are applied to the 2D facial image 400 for aligning the 2D facial image 400 and the plurality of first facial landmark points 404 in a straight horizontal line.

FIG. 4E illustrates a 2D polygonal facial mesh 406 created from the plurality of first facial landmark points 404 of FIG. 4D, in accordance with an example embodiment. After the 2D facial image 400 is straightened, the 2D polygonal facial mesh 406 is created by the 2D polygonal facial mesh engine 206 as described in FIG. 2. Each point on the plurality of first facial landmark points 404 is considered as a vertex of the 2D polygonal facial mesh 406. When one or more vertices of the 2D polygonal facial mesh 406 are modified, subsequently facial features of the face 402 also transform to depict changes in the 2D polygonal facial mesh 406. For example, when a vertex 408 present at an edge of right eye is moved outwards, shape of the eye will be stretched. In another example scenario, if vertices 410 and 412 present in edges of lips are stretched (pulled out), then the lips are widened. It shall be noted that when the vertices 410, 412 corresponding to the lips are widened, the other vertices in the 2D polygonal facial mesh 406 do not change and facial features of the face 402 such as eyes and nose remain unaffected due to change in the vertices 410, 412 associated with the lips.

FIGS. 4F and 4G illustrate the 2D facial image 400 for applying one or more averaging techniques depicting at least a symmetrical jawline for the 2D facial image 400 based on direction associated with the facial profile, in accordance with an example embodiment of the present disclosure. After the 2D polygonal facial mesh 406 is created, an averaging to the 2D facial image 400 is performed. The averaging to the 2D facial image 400 is performed for obtaining a symmetrical facial structure corresponding to the 2D facial image 400. For example, a face in the 2D facial image 400 may be slightly turned to left side or right side. In such scenario, one or more averaging techniques may be applied to obtain a symmetrical facial structure corresponding to the 2D facial image 400. In one example embodiment, one or more averaging techniques are applied on the plurality of first facial landmark points 404 based on a golden ratio for generating a plurality of second landmark points. Moreover, the averaging facilitates a mirroring of left side profile and right side profile of the face 402. The mirroring includes determining a rate of change in set of facial landmarks based on a facial side profile that may represent a better facial structure. The rate of change in the set of facial landmarks is then applied to acquire the symmetric facial structure of the face 402 including a symmetric jawline.

In an example scenario, a jawline 414 of the face 402 is averaged by determining a direction associated with a facial profile of the 2D facial image 400 from the plurality of first facial landmark points 404. The direction associated with a facial profile is based on at least one of a left side profile and a right side profile. At least one set of facial landmark points is selected based on the direction associated with the facial profile of the 2D facial image 400. For example, if the face 402 is slightly facing to right direction, then a set of facial landmark points 416a associated with right side profile is selected for generating the symmetric jawline 414. The selected set of facial landmark points 416a is used for mirroring on a set of facial landmark points 416b associated with left side profile. It is noted here that selection of facial side profile is based on perspective view of a user.

FIG. 4H illustrates the plurality of second facial landmark points obtained by applying one or more averaging techniques on the first facial landmark points of FIG. 4F, in accordance with an example embodiment. In at least one example embodiment, the plurality of second facial landmark points includes a set of facial landmark points 418a, 418b, 418c, 418d, 418e, 418f, 418g and additional landmark points 419a, 419b, 419c, 419d, 419e, 419f, 419g. The set of facial landmark points 418a, 418b, 418c, 418d, 418e, 418f, 418g are added to the 2D facial image 400 depicting the face 402 along with the plurality of second facial landmark points. The additional landmark points 419a, 419b, 419c, 419d, 419e, 419f, 419g are added on edge of the 2D facial image 400. As shown in FIG. 4H, the facial landmark points 418c and 418d are added on each side of two horizontal lines defined by an outer edge point of the eyes and an outer edge point of the eyebrows. The facial landmark points 418e, 418f and 418g are added at an upper edge of the 2D facial image 400.

FIG. 4I illustrates the 2D polygonal mesh 406 of FIG. 4E updated based on the plurality of second facial landmark points (418a-g & 419a-g) of FIG. 4H, in accordance with an example embodiment of the present disclosure. After generating plurality of second facial landmark points (418a-g & 419a-g), the 2D polygonal facial mesh 406 is updated based on the plurality of second facial landmark points (418 a-g & 419a-g).

FIG. 4J illustrates an example representation of extracting a plurality of skin tones from the 2D facial image 400 of FIG. 4C, in accordance with an example embodiment. The plurality of skin tones are extracted from at least a left side 420a of the left side profile, a frontal side 420b including nose lobe and a right side 420c of the right side profile. After the plurality of skin tones is extracted, facial texture is generated as is shown in FIG. 4K.

FIG. 4K illustrates an example representation of generating facial texture from the 2D facial image 400 of FIG. 4C, in accordance with an example embodiment. Facial texture is generated so as to preserve lighting effects of the 2D facial image 400. In at least one example embodiment, the facial texture is generated by removing a plurality of pixels from the 2D facial image 400. The removed plurality of pixels are replaced for preserving lighting effects of the 2D facial image 400 by performing a sampling of the skin tone from one or more pixels extracted from left side of left side profile, frontal side including nose lobe and right side of the right side profile. For example, when the facial texture is generated, a plurality of pixels from background of the 2D facial image 400 is removed. The plurality of pixels from background is replaced for preserving lighting effects of the 2D facial image 400 by performing a sampling of skin tone from one or more pixels extracted from the left side 420a, the frontal side 420b and the right side 420c, as shown in FIG. 4J.

The pixels in the background are replaced in such a way that darker side due to facial hair is filled with darker pixels. Likewise, lighter side is filled with lighter pixels in the background. It may be understood here that removal of unwanted pixels may include performing beautification of the face 402. The beautification may include removal of blemishes from the face 402 or the facial hair extending outside portion of the face 402.

The facial graphics data obtained from the 2D facial image 400 are mapped to a generic 3D head model for rendering a 3D facial model of the face 402, which is explained with reference to FIGS. 5A and 5B.

FIG. 5A illustrates an example representation 500 of mapping a plurality of facial graphics data extracted by the image processing module 200 of FIG. 2 on a 3D generic head model 502, in accordance with an example embodiment of the present disclosure. 3D generic head model 502 is hereinafter interchangeably referred to as the head model 502. The head model 502 includes a skin along with a mask texture and a plurality of bones. The plurality of bones is formed by grouping vertices of the head model 502. The plurality of bones helps in changing shape of the head model 502. Moreover, movement of the plurality of bones facilitates animating expressions on the head model 502. The mask texture provides a transparency for eye sockets 504 and 506. The transparency helps in seeing inner side of eye area. Moreover, the mask texture facilitates a soft texture to edges of the head model 502. The head model 502 is divided into three sections for separately rendering eye sockets 504 and 506 using eye masks, ears and remaining parts of a face such as, the face 402 (shown in FIGS. 4A to 4J) to the head model 502. Furthermore, UV mapping may be employed for mapping the facial texture to the head model 502. An example of mapping the facial texture to the head model 502 is explained with reference to FIG. 7B.

FIG. 5B illustrates an example representation 550 of projecting the facial texture at a plurality of coordinates on the 3D generic head model 502 via a planar projection 552, in accordance with an example embodiment of the present disclosure. The facial texture is projected on the head model 502 to generate a user 3D head model 554. The facial texture is projected on the head model 502 by using the planar projection 552. The planar projection 552 is provided by the UV mapping engine 310 as described in FIG. 3. The planar projection 552 includes UV coordinates that are mapped to the head model 502. The head model 502 includes vertices that are baked with the UV coordinates. Once the vertices of the head model 502 and the UV coordinates are baked, the facial texture is morphed with the vertices of the head model 502 to generate the user 3D head model 554. The user 3D head model 554 is used by the 3D rendering engine 320 described in FIG. 3 for generating the 3D facial model as shown in FIG. 6A.

Furthermore, facial props are added to the user 3D head model 554 in such a way that the facial props automatically fit the user 3D head model 554. Moreover, each facial prop is exported as a skeletal mesh for automatic morphing, which is explained with reference to FIGS. 7A to 7C.

In an example embodiment, an application interface may cause display of one or more UIs for (1) capturing a 2D facial image, (2) receiving a first user input and a second user input for modifying one or more facial features, and (3) rendering a 3D facial model along with an avatar of the user. Example UIs displayed to the user 102 for displaying the 3D facial model and rendering the avatar are described with reference to FIGS. 6A to 6E.

FIG. 6A illustrates an example representation of a UI 600 displaying a 3D facial model 612 of a user on the application interface 114 for animating the 3D facial model 612 generated from the 2D facial image 400 of FIG. 4A, in accordance with an example embodiment of the present disclosure. It is noted that the user 102, the mobile device 104, the application interface 114 are shown in FIG. 1 and the 3D facial model 612 is shown in FIG. 5B. In an example scenario, the application interface 114 may be downloaded to the mobile device 104 from the server 108 shown in FIG. 1. An application icon may be displayed to the user 102 on the display screen of the mobile device 104. The application icon is not shown in FIG. 6A. Upon invoking the application interface 114, the UI 600 may provide options for the user to either capture a 2D facial image or upload a 2D facial image from a storage device. The mobile device 104 may send the 2D facial image 400 to the server 108 via the application interface 114. The server 108 is configured to process the 2D facial image and generate a plurality of facial graphics data that is received by the application interface 114 for rendering the 3D facial model 612 corresponding to the 2D facial image. The application interface 114 prompts the mobile device 104 to load a generic 3D head model (e.g., the 3D head model 502 in FIG. 5A) such that the plurality of facial graphics data can be morphed to generate the 3D facial model corresponding to the 2D facial image. It shall be noted that the morphing of the plurality of facial graphics data to the generic 3D head model and generating a user 3D head model (e.g., the user 3D head model 554 in FIG. 5B) are performed at the backend and only the 3D facial model 612 is displayed to the user 102. In one example embodiment, the user 102 may provide the second user input for modifying the 3D facial model 612. The 3D facial model 612 may be modified by modifying a plurality of facial graphics data such as one or more facial coordinates associated with one or more second facial landmark points of a plurality of second facial landmark points, modifying facial texture, and animating the 3D head model based on the second user input.

The UI 600 is depicted to include a header portion 601 that contains a menu tab 602, a title 603, and a help tab 604. The menu tab 602 may include options 605, 606 and 607. It shall be noted here that the options tab may list fewer or more options than those described herein. The option 605 associated with text ‘Customize’ provides options for modifying facial features of the 3D facial model and optionally adding facial props to the 3D facial model 612. The option 606 associated with text ‘Preview’ may provide a display of the 3D facial model 612 before completing customization of the 3D facial model 612. The option 607 associated with text ‘Export’ enables the user 102 to export the 3D facial model 612 to other external devices. The help tab 604 may provide a page that include information about the application, help center and report problem. The title 603 is associated with a text “3D Face”.

Furthermore, the UI 600 is depicted to include a camera capture tab 609, an album tab 610, and a share tab 611 overlaying a section displaying the 3D facial model 612. The camera capture tab 609 facilitates the user to access camera module of the mobile device to capture the 2D facial image. The album tab 610 facilitates the user to import the 2D facial image that may be stored in the mobile device or a remote database stored in a server. The options 605 may include options for adding different hairstyles, fashion accessories, etc. to the 3D facial model 612, which is shown in FIG. 6B. When the user clicks the options 605, an options page is displayed, which is shown in a UI 615 of FIG. 6B.

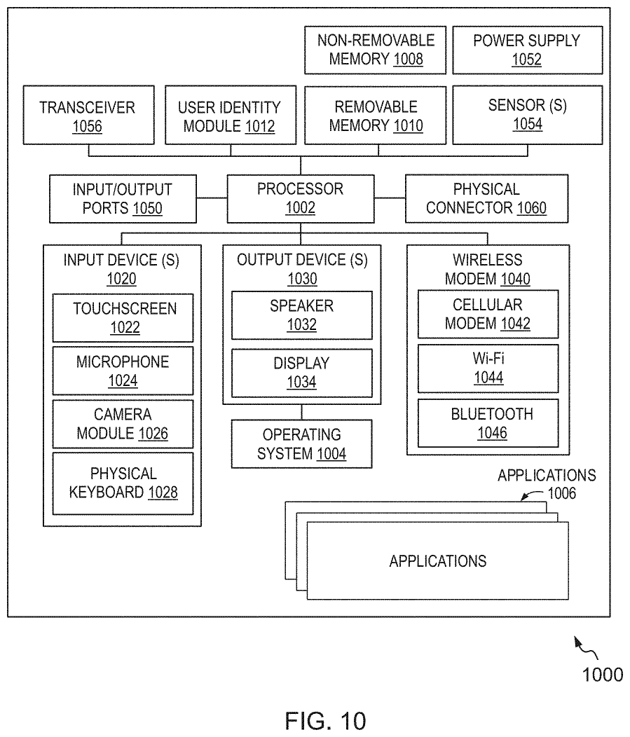

FIG. 6B illustrates an example representation of the UI 615 displayed to the user 102 on a display screen of the mobile device of FIG. 10 by the application interface 114, in accordance with an example embodiment of the present disclosure.

The UI 615 is depicted to include a header portion 616 and a content portion. The header portion 616 includes a title associated with text ‘CUSTOMIZE’ and an option 617. It shall be noted that the title may be associated with any other label/text other than the text depicted here. The user can provide a click input or a selection input on the option 617 so as to navigate to a UI accessed by the user prior to the UI 615 such as, the UI 600.

The content portion depicts the 3D facial model 612 as shown in FIG. 6A. The content portion includes a face tab 619, a hair tab 620 and a prop tab 621. The user can provide a click input or selection input on the face tab 619 for modifying one or more facial features such as, face width, eyes and jawline. An example of modifying facial features is shown and explained with reference to FIG. 6D. A selection input on the hair tab 620 displays various hairstyles and the user can select a hairstyle that can be morphed to fit the 3D facial model 612. An example UI depicting different hairstyles is shown and explained with reference to FIG. 6C. Similarly, a selection input on the prop tab 621 displays facial props such as, glasses, masks that can be used for animating the 3D facial model 612. It shall be noted that the facial props depicted in a content portion 618 may include fewer or more tabs than those depicted in FIGS. 6B-6D and the facial props depicted in FIGS. 6B-6D are shown for example purposes only.

FIG. 6C illustrates an example representation of a UI 625 displayed to the user 102 on a display screen of the mobile device of FIG. 10 by the application interface 114 depicting a facial prop on the 3D facial of FIG. 6, in accordance to an example embodiment of the present disclosure. The UI 625 is displayed on the mobile device 104 when the user provides a selection input on the hair tab of the UI 615 (shown in FIG. 6B).

In an embodiment, the UI 625 depicts a pop-up box 626 displaying a plurality of hairstyles 627a, 627b, 627c and 627d (also referred to as hairstyles 627). The user 102 may select a hairstyle from the hairstyles 627. The hairstyles 627 may include a wide range of hairstyles such as long hair, short hair, curly hair, straight hair, etc. In an example, the user 102 selects a hairstyle 627b and the hairstyle 627b is morphed to fit the 3D facial model 612. An example of morphing a hairstyle to adapt to the 3D facial model 612 is explained with reference to FIG. 7A-7B. It shall be noted that the hairstyles 627 depicted in FIG. 6C are shown for example purposes only and the UI 625 may include fewer, lesser or different hairstyles than those depicted in the UI 625.

FIG. 6D illustrates an example representation of a UI 630 displayed to the user 102 on a display screen of the mobile device of FIG. 10 by the application interface 114 for providing a first user input related to customization of the 3D facial model 612, in accordance to an example embodiment of the present disclosure. The UI 630 is displayed on the mobile device when the user provides a selection input on the face tab 619 of the UI 615.

The UI 630 is depicted to include a header portion 631 and a content portion. The header portion 631 includes a title associated with text ‘CUSTOMIZE’ and the option 617. The content portion includes options 634 and 635. The option 634 associated with text ‘FACE EDIT’ enables the user to modify facial features such as, face width. A click or selection of the option 634 causes a display of a pop-up box 636. The pop-up box 636 includes options for providing the first user input such as modifying face width, face straightening, eyes and jawline. In this example representation, each of the options face width, face straightening, eyes and jawline is associated with an adjustable slider, for example, option associated with text ‘Straighten’ is associated with a slider 637, an option associated with text ‘Face width’ is associated with a slider 638, an option associated with text ‘Scale eyes’ is associated with a slider 639 and an option associated with text ‘Super jaw’ is associated with a slider 640. The sliders 637, 638, 639 and 640 may be moved from left to right so as to modify one or more of face width, face straightening, eyes and jawline.

In one example scenario, when the user 102 moves the slider 638 towards a right side, face of the 3D facial model 612 is widened. In a similar manner, other facial features of the 3D facial model 612 may be customized using the sliders 637, 638, 639 and 640. The option 635 associated with text ‘COLOR EDIT’ enables the user to modify different facial features such as eyes or props added to the 3D facial model 612. For example, color of a facial prop such as a cap added to the 3D facial model 612 can be customized.

FIG. 6E illustrates an example representation of a UI 645 displayed to the user on a display screen of the mobile device of FIG. 10 by the application interface 114 displaying customization of props added to the 3D facial model 612, in accordance to an example embodiment of the present disclosure. The UI 645 is presented on the mobile device when the user provides a selection input on the option 635 of the UI 630.

The UI 645 is depicted to include a pop-up box 646 associated with a range of colors 647a, 647b, 647c and 647d (shown as color 1, color 2, color 3 and color 4). The pop-up box 646 further includes an adjustable slider 648 that enables the user 102 to customize color gradient based on the color, for example, color 1 selected by the user in the UI 645. In an example, the user 102 may select a facial feature, for example, eyes of the 3D facial model 612 and change color of the eyes. In another example, the user 102 may select a prop such as cap added to the 3D facial model 612 and change color of the cap. The user 102 may increase or decrease the gradient of the color 1 by moving the adjustable slider 648 in left or right directions.

In one example embodiment, when the facial props such as hair prop is added to the 3D facial model 612, occlusion mapping is performed which is explained with reference to FIGS. 7A to 7C.

Referring now to FIGS. 7A and 7B, a facial prop exporting as a 3D hair prop skeletal mesh 702 (as depicted in representation 700 of FIG. 7A) for morphing to a user 3D head model 722 (as depicted in representation 720 of FIG. 7B), in accordance with an example embodiment of the present disclosure. As shown in FIG. 6C, when a hair prop such as, the hairstyle 627b is added to the user 3D head model 722, the 3D hair prop skeletal mesh 702 corresponding to the hairstyle 627b is exported so as to enable morphing of the hairstyle 627b on the user 3D head model 722. In one example embodiment, the 3D hair prop skeletal mesh 702 is exported as skinned mesh using 3D authoring tools. The 3D hair prop skeletal mesh 702 exported as the skinned mesh includes bones that are influenced by a subset of bones from the user 3D head model 722 as shown in FIG. 7B. It is noted that the user 3D head model 722 is the user 3D head model 554 as described in FIG. 5B. The subset of bones in the user 3D head model 722 includes bones formed by vertices 724a-724k. The vertices 724a-724k influence the 3D hair prop skeletal mesh 702 and the user 3D head model 722 that morphs in sync and provide a realistic look. The vertices in the 3D hair prop skeletal mesh 702 that include vertices 704a-704e for a subset of bones in the 3D hair prop skeletal mesh 702 based on the subset of the bones of the user 3D head model 722. The bones of the user 3D head model 722 and the bones of the 3D hair prop skeletal mesh 702 move cohesively when one of the bones is moved. Moreover, bone weights on the vertices 704a-704e of the 3D hair prop skeletal mesh 702 match very closely to the vertices 724a-724k of the user 3D head model 722 that enable the 3D hair prop skeletal mesh 702 to automatically fit the user head model 722.

Moreover, when the 3D hair prop skeletal mesh 702 is added to the user 3D head model 722 shadow is casted on the user 3D head model 722. It may further be noted that shadow of the user 3D head model 722 is also casted to any prop added, such as the 3D hair prop skeletal mesh 702. It may be noted that each prop casts shadow differently to the user 3D head model 722 using an occlusion texture. For example, the shadow of the 3D hair prop skeletal mesh 702 is casted on the user 3D head model 722 by using an occlusion texture, which is shown in FIG. 7C.

FIG. 7C illustrates an example representation 740 of a prop occlusion texture 742 exhibited by the facial prop of FIG. 7A when morphed on the user 3D head model 722, in accordance with an example embodiment of the present disclosure.

An occlusion texture 740 is a representative of an Ambient Occlusion (referred to hereinafter as ‘AO term’) when the 3D hair prop skeletal mesh 702 is added to the user 3D head model 722. The AO term is determined by approximating light occlusion due to a nearby geometry at any given point in 3D space. For example, the occlusion texture 740 is representative of how the hairstyle 627b affects lighting on the face of the 3D facial model by casting shadows corresponding to the hairstyle 627b. Accordingly, each prop has an occlusion texture that defines the AO term on the user 3D head model 722. The prop occlusion texture 742 (see, area enclosed by dashed lines) projected on the user 3D head model 722 is represented by dark pixels that give an appearance of a soft shadow cast on the user 3D head model 722. In one example, when a different facial prop is morphed to the user 3D head model 722, an occlusion texture corresponding to the facial prop is applied. In one example embodiment, applying occlusion texture includes darkening certain pixels to create an illusion of shadow on the user 3D head model 722 due to the facial prop. As shown in FIG. 7C, the soft shadow is cast on forehead of the 3D facial model based on the hairstyle 627b. Furthermore, it shall be noted that the prop occlusion texture 742 stores only the AO term corresponding to the facial prop for the user 3D head model 722. While rendering the user 3D head model 722, the prop occlusion texture 742 is used to darken certain pixels so as to define the soft shadow cast by the facial prop such as the hairstyle 627b.

It may be noted that the AO term may be baked to the user 3D head model 722 using a 3D authoring tool. In one example embodiment, shadow on the facial props such as the 3D hair prop skeletal mesh 702 may be casted by the user 3D head model 722. In such cases, the AO term is stored in vertices of the 3D hair prop skeletal mesh 702, such as the vertices 704a-704e as described in FIGS. 7A and 7B.

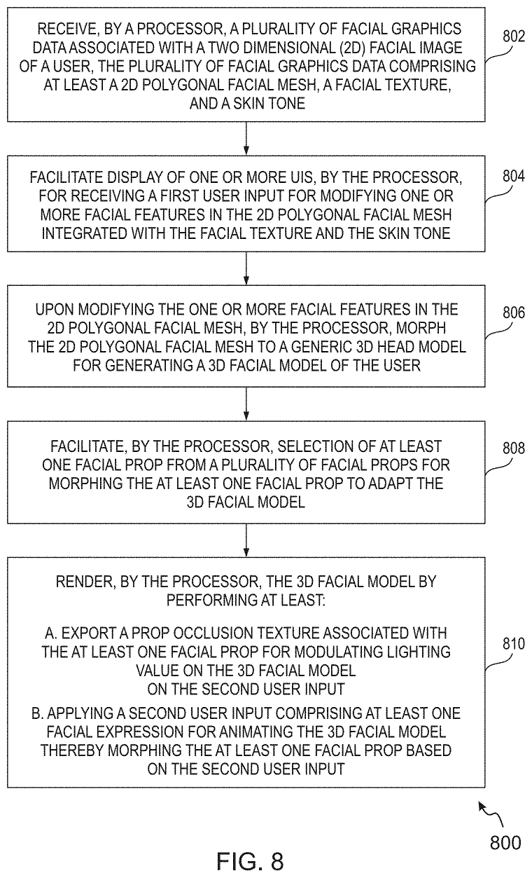

Referring now to FIG. 8, a flow diagram depicting a method 800 for rendering a 3D facial model from a 2D facial image provided by a user, is shown in accordance with an example embodiment. The method 800 depicted in the flow diagram may be executed by a processor, for example, the animation module 300 embodied in the mobile device 104 in FIG. 1. Operations of the flow diagram 800, and combinations of operation in the flow diagram 800, may be implemented by, for example, hardware, firmware, a processor, circuitry and/or a different device associated with the execution of software that includes one or more computer program instructions. Further, one or more operations may be grouped together and performed in form of a single step, or one operation may have several sub-steps that may be performed in parallel or in sequential manner. The operations of the method 800 are described herein with help of the animation module 300. It is noted that the operations of the method 800 can be described and/or practiced by using a system other than the animation module 300, such as the image processing module 200. The method 800 starts at operation 802.

At operation 802, the method 800 includes receiving, by a processor, a plurality of facial graphics data associated with the 2D facial image of the user. The plurality of facial graphics data includes at least a 2D polygonal facial mesh, a facial texture, and a skin tone. In an embodiment, the user may capture the 2D facial image using a camera module associated with a mobile device. In another embodiment, the user may provide the 2D facial image stored in the mobile device associated with the user. Alternatively, the user may access the 2D facial image from an external system or database configured to store images of the user. The user may send a request that includes a 2D facial image provided by a user and a request for processing the 2D facial image and subsequently extracting a plurality of facial graphics data from the 2D facial image. The request may be sent using an application interface installed in the mobile device, wherein the application interface may be provided by the server. The server may include an image processing module for processing the 2D facial image. Moreover, the image processing module may further include one or more engines to process 2D facial image and extract the plurality of facial graphics data. For example, the image processing module determines facial landmarks from the 2D facial image using facial landmark detection engine. From the facial landmarks a 2D polygonal facial mesh is generated using 2D face triangulation engine. The plurality of facial graphics data further includes facial texture and skin tone that are generated using facial texture generation engine and skin tone extraction engine respectively. Moreover, alignment correction and removal of unwanted pixels are also performed using face straightening engine and face averaging engine respectively. The plurality of facial graphics data extracted by the image processing module of the server is sent to the user via the application interface.

At operation 804, the method 800 includes facilitating display of one or more UIs, by the processor, for receiving a first user input for modifying one or more facial features in the 2D polygonal facial mesh integrated with the facial texture and the skin tone. In an embodiment, when the user receives the plurality of facial graphics data, the 2D facial mesh with the facial texture and the skin tone is rendered. The 2D facial mesh, the facial texture and the skin tone may be integrated using a real-time graphics application program interface (API), which may be performed as a backend process. The 2D facial mesh with the facial texture and skin tone is then displayed to the user via the application in the mobile device. The user may then apply changes to the 2D facial mesh with the facial texture and skin tone. Whenever changes are applied by the user, the plurality of facial graphics data is updated. In one example embodiment, the user may be presented with options for applying changes to facial features such as face width, face alignment, eye scale and jawline. Moreover, golden ratio value is included in applying changes to the facial features that facilitates an accurate facial shape and structure.

The method 800 also includes modifying the one or more facial features in the 2D polygonal facial mesh, by the processor. Further, upon modifying, at operation 806, the method 800 includes morphing the 2D polygonal facial mesh to a generic 3D head model for generating a 3D facial model of the user. In an example embodiment, the 3D head model may be generated using 3D authoring tools. The 3D facial model is then exported as a skinned mesh that may include 64 individual bones. It may be noted here the bones are formed by grouping vertices in the skinned mesh of the 3D facial model. Moreover, bone weights are applied to the bones of the 3D facial model the bones and the vertices in the skinned mesh move cohesively. Furthermore, the 3D facial model includes UV mapping that helps in applying facial texture to the 3D facial model. The facial texture is projected to 3D facial model using a planar projection.

At operation 808, the method 800 includes facilitating, by the processor, selection of at least one facial prop from a plurality of facial props for morphing the at least one facial prop to adapt to the 3D facial model. In an example embodiment, the facial props include any accessories, clothing, etc. that can be added to the 3D facial model. Each facial prop is exported as a skinned mesh that includes bones influenced by a subset of bones from a 3D head model of the 3D facial model. Such an approach enables the props to automatically fit the 3D facial model.

At operation 810, the method 800 includes rendering, by the processor, the 3D facial model by performing at least exporting a prop occlusion texture associated with the at least one facial prop for modulating lighting value on the 3D facial model and applying a second user input for animating the 3D facial model thereby morphing the at least one facial prop based on the second user input. In an embodiment, facial props are added to the 3D facial model in such a way that the facial props cast shadow to the 3D facial model. The shadows are casted to the 3D facial model when the props are added using occlusion texture. The occlusion texture determines an ambient occlusion term casting a soft shadow to the 3D facial model. Moreover, the 3D facial model may also cast shadows to the props. The occlusion texture is stored in vertices of the 3D head model of the 3D facial model that helps in casting shadows to the props.

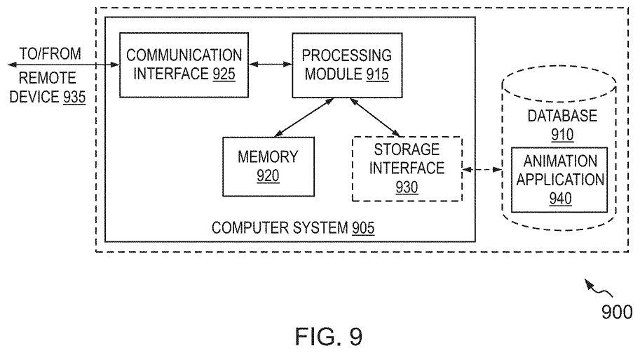

FIG. 9 illustrates a block diagram representation of a server 900 capable of implementing at least some embodiments of the present disclosure. The server 900 is configured to host and manage the application interface 114 that is provided to a mobile device such as the mobile device 104, in accordance with an example embodiment of the invention. An example of the server 900 is the server 108 as shown and described with reference to FIG. 1. The server 900 includes a computer system 905 and a database 910.

The computer system 905 includes at least one processing module 915 for executing instructions. Instructions may be stored in, for example, but not limited to, a memory 920. The processor 915 may include one or more processing units (e.g., in a multi-core configuration).

The processing module 915 is operatively coupled to a communication interface 925 such that the computer system 905 is capable of communicating with a remote device 935 (e.g., the mobile device 104) or communicates with any entity within the network 106 via the communication interface 925. For example, the communication interface 925 may receive a user request from the remote device 935. The user request includes a 2D facial image provided by a user and a request for processing the 2D facial image and subsequently extracting a plurality of facial graphics data from the 2D facial image.

The processing module 915 may also be operatively coupled to the database 910 including executable instructions for an animation application 940. The database 910 is any computer-operated hardware suitable for storing and/or retrieving data, such as, but not limited to, 2D facial images, 3D facial models, plurality of facial graphics data, and information of the user or data related to functions of the animation application 940. The database 910 stores 3D facial models that were created using the application interface 114 so as to maintain a historical data that may be accessed based on a request received from the user. Optionally, the database 910 may also store the plurality of facial graphics data extracted from the 2D facial image. The database 910 may include multiple storage units such as hard disks and/or solid-state disks in a redundant array of inexpensive disks (RAID) configuration. The database 910 may include a storage area network (SAN) and/or a network attached storage (NAS) system.

In some embodiments, the database 910 is integrated within the computer system 905. For example, the computer system 905 may include one or more hard disk drives as the database 910. In other embodiments, the database 910 is external to the computer system 905 and may be accessed by the computer system 905 using a storage interface 930. The storage interface 930 is any component capable of providing the processing module 915 with access to the database 910. The storage interface 930 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processing module 915 with access to the database 910.

The processing module 915 is further configured to receive the user request comprising the 2D facial image for processing and extracting the plurality of facial graphics data. The processing module 915 is further configured to perform: detect a plurality of first facial landmark points on the 2D facial image, align the 2D facial image along with the plurality of first facial landmark points on a straight horizontal line, generate a symmetrical facial structure by applying one or more averaging techniques to a jawline of the user on the 2D facial image, extract facial texture and skin tone of the user from the 2D facial image and generate the 2D polygonal facial mesh from the plurality of second facial landmark points.

FIG. 10 illustrates a mobile device 1000 capable of implementing the various embodiments of the present invention. The mobile device 1000 is an example of the mobile device 104.

It should be understood that the mobile device 1000 as illustrated and hereinafter described is merely illustrative of one type of device and should not be taken to limit the scope of the embodiments. As such, it should be appreciated that at least some of the components described below in connection with that the mobile device 1000 may be optional and thus in an example embodiment may include more, less or different components than those described in connection with the example embodiment of the FIG. 10. As such, among other examples, the mobile device 1000 could be any of a mobile device, for example, cellular phones, tablet computers, laptops, mobile computers, personal digital assistants (PDAs), mobile televisions, mobile digital assistants, or any combination of the aforementioned, and other types of communication or multimedia devices.

The illustrated mobile device 1000 includes a controller or a processor 1002 (e.g., a signal processor, microprocessor, ASIC, or other control and processing logic circuitry) for performing such tasks as signal coding, data processing, image processing, input/output processing, power control, and/or other functions. An operating system 1004 controls the allocation and usage of the components of the mobile device 1000 and support for one or more applications programs (see, applications 1006), such as an application interface for facilitating generation of a 3D facial model from a 2D facial image provided by a user (e.g., the user 102). In addition to the application interface, the applications 1006 may include common mobile computing applications (e.g., telephony applications, email applications, calendars, contact managers, web browsers, messaging applications such as USSD messaging or SMS messaging or SIM Tool Kit (STK) application) or any other computing application.

The illustrated mobile device 1000 includes one or more memory components, for example, a non-removable memory 1008 and/or a removable memory 1010. The non-removable memory 1008 and/or the removable memory 1010 may be collectively known as database in an embodiment. The non-removable memory 1008 can include RAM, ROM, flash memory, a hard disk, or other well-known memory storage technologies. The removable memory 1010 can include flash memory, smart cards, or a Subscriber Identity Module (SIM). The one or more memory components can be used for storing data and/or code for running the operating system 1004 and the applications 1006. The mobile device 1000 may further include a user identity module (UIM) 1012. The UIM 1012 may be a memory device having a processor built in. The UIM 1012 may include, for example, a subscriber identity module (SIM), a universal integrated circuit card (UICC), a universal subscriber identity module (USIM), a removable user identity module (R-UIM), or any other smart card. The UIM 1012 typically stores information elements related to a mobile subscriber. The UIM 1012 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The mobile device 1000 can support one or more input devices 1020 and one or more output devices 1030. Examples of the input devices 1020 may include, but are not limited to, a touch screen/a screen 1022 (e.g., capable of capturing finger tap inputs, finger gesture inputs, multi-finger tap inputs, multi-finger gesture inputs, or keystroke inputs from a virtual keyboard or keypad), a microphone 1024 (e.g., capable of capturing voice input), a camera module 1026 (e.g., capable of capturing still picture images and/or video images) and a physical keyboard 1028. Examples of the output devices 1030 may include, but are not limited to a speaker 1032 and a display 1034. Other possible output devices can include piezoelectric or other haptic output devices. Some devices can serve more than one input/output function. For example, the touch screen 1022 and the display 1034 can be combined into a single input/output device.

A wireless modem 1040 can be coupled to one or more antennas (not shown in FIG. 10) and can support two-way communications between the processor 1002 and external devices, as is well understood in the art. The wireless modem 1040 is shown generically and can include, for example, a cellular modem 1042 for communicating at long range with the mobile communication network, a Wi-Fi compatible modem 1044 for communicating at short range with an external Bluetooth-equipped device or a local wireless data network or router, and/or a Bluetooth-compatible modem 1146. The wireless modem 1040 is typically configured for communication with one or more cellular networks, such as a GSM network for data and voice communications within a single cellular network, between cellular networks, or between the mobile device 1000 and a public switched telephone network (PSTN).

The mobile device 1000 can further include one or more input/output ports 1050 for sending a 2D facial image to a server (e.g., the server 108) and receiving a plurality of facial graphics data from the server 108, a power supply 1052, one or more sensors 1054 for example, an accelerometer, a gyroscope, a compass, or an infrared proximity sensor for detecting the orientation or motion of the mobile device 1000 and biometric sensors for scanning biometric identity of an authorized user, a transceiver 1056 (for wirelessly transmitting analog or digital signals) and/or a physical connector 1060, which can be a USB port, IEEE 1294 (FireWire) port, and/or RS-232 port. The illustrated components are not required or all-inclusive, as any of the components shown can be deleted and other components can be added.

With the processor 1002 and/or other software (e.g., the application 1006) or hardware components, the mobile device 1000 can perform at least: cause provisioning of one or more UIs for receiving a first user input for modifying one or more facial features, generate a 3D facial model based on the plurality of facial graphics data received from the server, facilitate selection of at least one facial prop by the user, morph the facial prop to adapt for the 3D facial model of the user and apply an occlusion texture corresponding to the at least one facial prop so as to render a realistic 3D facial model of the user.

The 3D facial model may be shared to other applications for creating an avatar of a user. The other applications may include augmented reality (AR) applications, online gaming applications, etc. In one example, the 3D facial model may be morphed to an animated 3D body to create the avatar. Moreover, the avatar may be used for creating various emojis as animated graphics interchange format (GIF).

The disclosed methods or one or more operations of the flow diagram disclosed herein may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), mobile communications, or other such communication means.

Various embodiments of the disclosure, as discussed above, may be practiced with steps and/or operations in a different order, and/or with hardware elements in configurations, which are different than those which, are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A method, comprising:
receiving, by a processor, a plurality of facial graphics data associated with a two dimensional (2D) facial image of a user, the plurality of facial graphics data comprising at least a 2D polygonal facial mesh, a facial texture, and a skin tone;
facilitating display of one or more UIs, by the processor, for receiving a first user input for modifying one or more facial features in the 2D polygonal facial mesh integrated with the facial texture and the skin tone;
upon modifying the one or more facial features in the 2D polygonal facial mesh, by the processor, morphing the 2D polygonal facial mesh to a generic three dimensional (3D) head model for generating a 3D facial model of the user;
facilitating, by the processor, selection of at least one facial prop from a plurality of facial props for morphing the at least one facial prop to adapt to the 3D facial model; and
rendering, by the processor, the 3D facial model by performing at least:
exporting a prop occlusion texture associated with the at least one facial prop for modulating lighting value on the 3D facial model; and
applying a second user input comprising at least one facial expression for animating the 3D facial model thereby morphing the at least one facial prop based on the second user input.

2. The method as claimed in claim 1, further comprising prior to receiving the plurality of facial graphics data sending, by the processor, a user request to a server system, the user request comprising at least:
the 2D facial image of the user; and
a request for processing the 2D facial image of the user,
wherein upon receipt of the user request, the server system is configured to perform at least
determining a plurality of first facial landmark points from the 2D facial image,
applying one or more transforms for rotating the 2D facial image and the plurality of first facial landmark points, the one or more transforms configured to align the 2D facial image on a straight horizontal line,
applying one or more averaging techniques on the plurality of first facial landmark points based on a golden ratio for generating a plurality of second facial landmark points, the plurality of second facial landmark points depicting a symmetrical facial structure corresponding to the 2D facial image,
generating the 2D polygonal facial mesh from the plurality of second facial landmark points, and
extracting the facial texture and the skin tone of the user from the 2D facial image.

3. The method as claimed in claim 2, wherein morphing the 2D polygonal facial mesh further comprises:
exporting, by the processor, the generic 3D head model comprising a skinned mesh with a plurality of bones, each bone associated with a bone weight;
mapping, by the processor, the plurality of second facial landmark points to the plurality of bones for adapting each of the bone weight in the skinned mesh; and
applying, the facial texture to the skinned mesh using UV mapping for generating the 3D facial model.

4. The method as claimed in claim 2, wherein applying one or more averaging techniques further comprises:
determining a direction associated with a facial profile of the 2D facial image from the plurality of first facial landmark points, the direction of the facial profile being at least one of a left side profile and a right side profile;
selecting at least one set of facial landmark points based on the direction associated with the facial profile of the 2D facial image, the at least one set of facial landmark points being at least one of: a left side facial landmark points associated with the left side profile; and a right side facial landmark points associated with the right side profile;
generating the symmetrical facial structure corresponding to the 2D facial image by mirroring the set of facial landmark points based on the selection; and
updating the 2D polygonal facial mesh based on the symmetrical facial structure.

5. The method as claimed in claim 4, wherein generating the symmetrical facial structure of the 2D facial image further comprises:
defining at least a jawline for the 2D facial image based on the direction associated with the facial profile.

6. The method as claimed in claim 4, wherein mirroring further comprises:
determining a rate of change in the set of facial landmark points based on the selection;
applying the rate of change associated with the set of facial landmark points to a jawline; and
displaying a symmetric jawline on the symmetrical facial structure.

7. The method as claimed in claim 4, wherein extracting the skin tone further comprises extracting a plurality of skin tones from the 2D facial image, wherein the plurality of skin tones are extracted from at least:
a left side of the left side profile;
a frontal side including a nose lobe; and
a right side of the right side profile.

8. The method as claimed in claim 7, wherein extracting the facial texture further comprises:
removing a plurality of pixels from the 2D facial image, the plurality of pixels comprising one or more of a background pixel or an obnoxious pixel; and
replacing the plurality of pixels for preserving lighting effects of the 2D facial image by performing a sampling of the skin tone from one or more pixels extracted from the left side, the frontal side and the right side.

9. The method as claimed in claim 8, further comprising:
projecting, by the processor, the facial texture at a plurality of coordinates in the skinned mesh via a planar projection; and
baking, by the processor, the plurality of coordinates associated with the planar projection into bones of the skinned mesh for animating expressions in the generic 3D head model.

10. The method as claimed in claim 1, wherein the first user input is for modifying one or more of:
a face width;
a face straightening;
an eye scaling; and
a jawline of the 2D polygonal facial mesh.

11. The method as claimed in claim 1, further comprising:
facilitating, by the processor, an application interface for receiving the second user input for modifying the plurality of facial graphics data; and
animating, by the processor, the generic 3D head model of the user based on the second user input.

12. The method as claimed in claim 11, wherein modifying the plurality of facial graphics data comprises modifying:
one or more facial coordinates associated with one or more second facial landmark points of the plurality of second facial landmark points; and
the facial texture based on the second user input.

13. The method as claimed in claim 1, wherein rendering the 3D facial model further comprises:
assigning, by the processor, the skin tone extracted from the left side of a left side profile to a left light color, the skin tone extracted from the right side of a right side profile to a right light color, the skin tone extracted from a frontal side of a nose lobe profile to a front light color;
identifying, by the processor, a minimum value color from at least one of the left light color, the right light color and the front light color; and
assigning, by the processor, the minimum value color as an ambient light color associated with the background.

14. The method as claimed in claim 13, further comprises:
determining, by the processor, an approximated average skin color based on the skin tone; and
rendering, by the processor, lighting values for the 3D facial model by performing:
subtracting, by the processor, the ambient light color from the left light color, the right light color and the front light color; and
upon subtracting, by the processor, dividing the ambient light color, the left light color, the right light color and the front light color by the approximated average skin color for obtaining the lighting values.

15. A mobile device for use by a user, the mobile device comprising:
an image capturing module configured to capture a 2D facial image of the user; and
a processor in operative communication with the image capturing module, the processor configured to:
determine a plurality of facial graphics data from the 2D facial image, the plurality of facial graphics data comprising at least a 2D polygonal facial mesh, a facial texture, and a skin tone;
facilitate display of one or more UIs, by the processor, for receiving a first user input for modifying one or more facial features in the 2D polygonal facial mesh integrated with the facial texture and the skin tone;
upon modifying the one or more facial features in the 2D polygonal facial mesh, morph the 2D polygonal facial mesh to a generic three dimensional (3D) head model for generating a 3D facial model of the user;
facilitate selection of at least one facial prop from a plurality of facial props for morphing the at least one facial prop to adapt to the 3D facial model; and
render the 3D facial model by performing at least:
exporting a prop occlusion texture associated with the at least one facial prop for modulating lighting value on the 3D facial model; and
applying a second user input comprising at least one facial expression for animating the 3D facial model thereby morphing the at least one facial prop based on the second user input.

16. The mobile device as claimed in claim 15, wherein the processor is configured to send a user request to a server system, the user request comprising at least:
the 2D facial image of the user; and
a request for processing the 2D facial image of the user,
wherein upon receipt of the user request, the server system is configured to perform at least
determining a plurality of first facial landmark points from the 2D facial image,
applying one or more transforms for rotating the 2D facial image and the plurality of first facial landmark points, the one or more transforms configured to align the 2D facial image on a straight horizontal line,
applying one or more averaging techniques on the plurality of first facial landmark points based on a golden ratio for generating a plurality of second facial landmark points, the plurality of second facial landmark points depicting a symmetrical facial structure corresponding to the 2D facial image,
generating the 2D polygonal facial mesh from the plurality of second facial landmark points, and
extracting the facial texture and the skin tone of the user from the 2D facial image.

17. The mobile device as claimed in claim 16, wherein for morphing the 2D polygonal facial mesh, the processor is configured to:
export the generic 3D head model comprising a skinned mesh with a plurality of bones, each bone associated with a bone weight;
map the plurality of second facial landmark points to the plurality of bones for adapting each of the bone weight in the skinned mesh; and
apply the facial texture to the skinned mesh using UV mapping for generating the 3D facial model.

18. A server system, comprising:
a database configured to store executable instructions for an animation application; and
a processing module in operative communication with the database, the processing module configured to provision the animation application to one or more user devices upon request, the processing module is configured to perform:
determining a plurality of facial graphics data associated with a 2D facial image of a user, the plurality of facial graphics data comprising at least a 2D polygonal facial mesh, a facial texture, and a skin tone; and
send the plurality of facial graphics data to a mobile device comprising an instance of the animation application, wherein the mobile device is configured to
facilitate display of one or more UIs for receiving a first user input for modifying one or more facial features in the 2D polygonal facial mesh integrated with the facial texture and the skin tone;
upon modifying the one or more facial features in the 2D polygonal facial mesh, morph the 2D polygonal facial mesh to a generic three dimensional (3D) head model for generating a 3D facial model of the user;
facilitate selection of at least one facial prop from a plurality of facial props for morphing the at least one facial prop to adapt to the 3D facial model; and
render the 3D facial model by performing at least:
exporting a prop occlusion texture associated with the at least one facial prop for modulating lighting value on the 3D facial model; and
applying a second user input comprising at least one facial expression for animating the 3D facial model thereby morphing the at least one facial prop based on the second user input.

19. The server system as claimed in claim 18, wherein for determining the plurality of facial graphics data, the processing module is configured to:
determine a plurality of first facial landmark points from the 2D facial image;
apply one or more transforms for rotating the 2D facial image and the plurality of first facial landmark points, the one or more transforms configured to align the 2D facial image on a straight horizontal line;
perform one or more averaging techniques on the plurality of first facial landmark points based on a golden ratio for generating a plurality of second facial landmark points, the plurality of second facial landmark points depicting a symmetrical facial structure corresponding to the 2D facial image;
generate the 2D polygonal facial mesh from the plurality of second facial landmark points; and
extract the facial texture and the skin tone of the user from the 2D facial image.

20. The server system as claimed in claim 19, wherein for performing one or more averaging techniques, the processing module is configured to further perform:
determining a direction associated with a facial profile of the 2D facial image from the plurality of first facial landmark points, the direction of the facial profile being at least one of a left side profile and a right side profile;
selecting at least one set of facial landmark points based on the direction associated with the facial profile of the 2D facial image, the at least one set of facial landmark points being at least one of: a left side facial landmark points associated with the left side profile; and a right side facial landmark points associated with the right side profile;
generating the symmetrical facial structure corresponding to the 2D facial image by mirroring the set of facial landmark points based on the selection; and
updating the 2D polygonal facial mesh based on the symmetrical facial structure.
